(19) United States
(12) Patent Application Publication
(10) Pub. No.: US 2009/0128360 A1
(43) Pub. Date: May 21, 2009

(54) ELECTRONIC TAG LOCATION SYSTEM

(75) Inventors: Mike Bianchi, Minneapolis, MN (US); Alex Fjelstad, Hopkins, MN (US)

Correspondence Address: SCHWEGMAN, LUNDBERG & WOESSNER, P.A., P.O. BOX 2938, MINNEAPOLIS, MN, 55402, US

(73) Assignee: HEADWATER SYSTEMS, INC., Minneapolis, MN (US)

(21) Appl. No.: 12/237,124

(22) Filed: Sep. 24, 2008

Related U.S. Application Data
(60) Provisional application No. 60/974,720, filed on Sep. 24, 2007.

(51) Int. Cl. G08B 5/22

(52) U.S. Cl. 340/825.49

(57) ABSTRACT

A system for locating one or more radio frequency identification (RFID) tags, the system comprising a radio frequency (RF) receiver including a receiver processor, the receiver adapted to programmably adjust reception range depending on a programmably variable attenuation parameter, the receiver further adapted to receive identification data from the one or more RFID tags, and a system host adapted to receive RFID tag data from any of the one or more RFID tags within the reception range and receiver attenuation data associated with the receiver, and provide an estimated location area for a received RFID tag using the RFID tag data and the receiver attenuation data. Other examples include methods for determining an RFID tag's location.

### RELATED APPLICATIONS

This application claims the benefit under 35 U.S.C. 119(e) of U.S. Provisional Patent Application Ser. No. 60/974,720 filed Sep. 24, 2007, which is incorporated herein by reference in its entirety.

### TECHNICAL FIELD

This document relates to electronic asset management systems and more particularly to electronic asset location systems using adjustable reception of radio frequency identification (RFID) tags.

### BACKGROUND

Radio frequency identification (RFID) tags are small electronic devices storing and communicating wirelessly a finite amount of information. Information is stored or retrieved from RFID tags using a tag reader. Because the tags are small, energy is conserved by limiting the power and frequency with which an RFID tags transmits, or chirps, stored data. As a result, programmers must be relatively close to the tags to read the data and in that position when the data is transmitted. It can be very time consuming to locate a particular RFID tag when the location is only generally known, such as, somewhere within a large warehouse. What is needed in the art is a system for quickly locating and monitoring one or more RFID tags within a generally defined area.

### SUMMARY

In general, the system includes one or more tags, one or more receivers and one or more host computers. The system includes functions to track the position of the tags using strategically placed receivers which receive and decode radio frequency (RF) signals from the tags. In various embodiments, the receivers are strategically placed in the sense that each receiver's reception range will overlap at least one other receiver's reception range for a range of attenuation levels. The receivers pass decoded data from the tags to the host computers. Software running on the host computers record and analyze the decoded data and then generate a probabilistic graphic of the data to highlight the most probable locations of the tags within a space or facility. In various embodiments, the tags communicate to the receiver using a “chirp” transmission. Tags and receivers are designed to communicate necessary information in a “chirp” as fast as possible to reduce drainage of the tags power source. The system finds practical application when the tags are associated with significant assets such as equipment or inventory items in settings where these items may be moved about in an unpredictable fashion but being able to find them quickly or to verify that they remain within the space or facility is essential to the user.

This Summary is an overview of some of the teachings of the present application and is not intended to be an exclusive or exhaustive treatment of the present subject matter. Further details about the present subject matter are found in the detailed description and the appended claims. The scope of the present invention is defined by the appended claims and their equivalents.

### BRIEF DESCRIPTION OF THE DRAWINGS

FIG. 1 illustrates an electronic tag location system according to one embodiment of the present subject matter.

FIG. 2A illustrates a system according to one embodiment of the present subject matter.

FIG. 2B illustrates the embodiment of FIG. 2A at a period of time, t₁, subsequent to time to illustrated in FIG. 2A.

FIG. 2C illustrates the embodiment of FIGS. 2A and 2B at a period of time t₂ subsequent to time t₁ illustrated in FIG. 2B.

FIG. 3 illustrates a discrete attenuation table according to one embodiment of the present subject matter.

### DETAILED DESCRIPTION

The following detailed description of the present invention refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

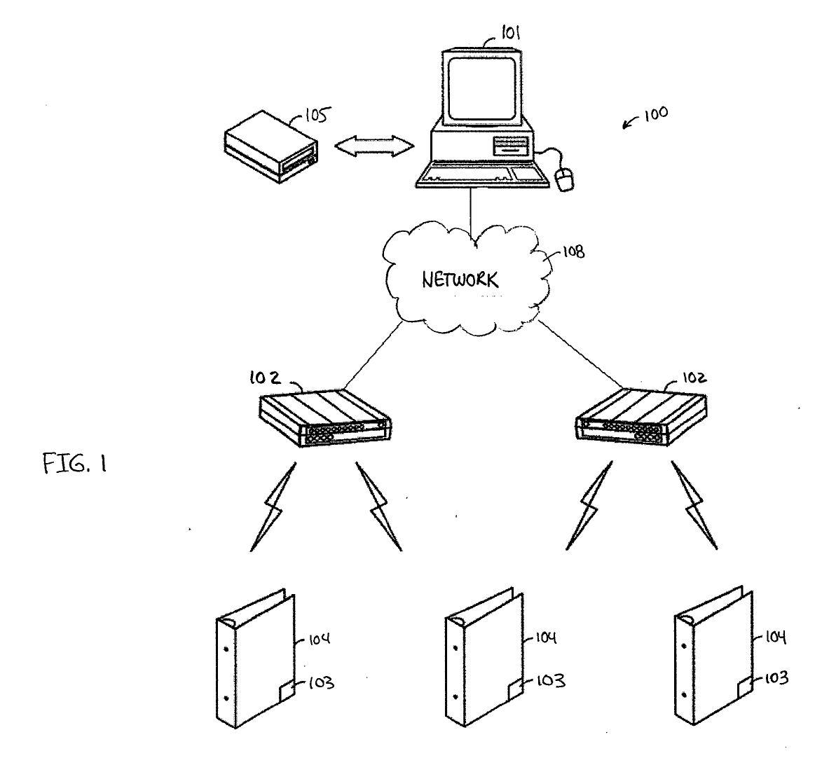

FIG. 1 illustrates an electronic tag location system 100 according to one embodiment of the present subject matter. FIG. 1 includes a system host computer 101, radio frequency receivers 102 and radio frequency identification (RFID) tags 103 attached to assets 104 of interest. In various embodiments, the system host and receivers are connected over a network 108. The network, for example, may include a local area network (LAN), a wide area network (WAN) and other network configurations known in the art, including combinations thereof. In various embodiments, connections to the network may be wired, wireless or a combination thereof. In various embodiments, a tag programmer 105 is used to program the tags. In various embodiments, the tag programmer 105 is used in conjunction with the system host 101 computer. Tags are programmed with data to allow identification of the tag, such data may include a number or series of characters, for example. In various embodiments, tags are programmed with timing information associated with “chirping” or transmitting the tags identification (ID) data according to the tags preprogrammed timing schedule. The tags transmit or “chirp” the data using a wireless transmission method, such as a radio frequency (RF) signal, for example. In various embodiments, an application, running on the system host, for example, coordinates tag programming to sequence tag ID's and timing data. In various embodiments, the application assists in associating assets of interest with each tag for future reference. In various embodiments, timing data is varied on tags to minimize two or more tags from chirping at the same time. In the illustrated embodiment of FIG. 1, the programmed tags chirp information using RF signals according to each tags timing data. The chirped RF signals are received by receivers 102 whose reception area includes the location of a tag. The chirped signals are decoded by the receivers 102 and stored, along with receiver data at the receiver. Setting up the system includes strategically locating each receiver and establishing a coordinate system to allow the system host 101 to determine location probabilities for detected tags 103.

The system host continuously combines the “chirped” information collected at the receivers and uses that information to determine regions where an object of interest is most likely to reside. In various embodiments, the information collected by each receiver includes numbers representing tag signal events (chirps) and is presented in the form of a web page, herein, the chirp page. In various embodiments, each number greater than 0 represents a Tag ID number indicating that a signal has been received from that tag. In various embodiments, each receiver also hosts a receiver host page, the receiver host page includes a form used to receive “data received” acknowledgments and operating parameters for the receiver. The receiver's web pages are available to a LAN (Local Area Network). In various embodiments, a system host computer resides on the LAN and includes applications to continuously interact with the receivers using Ethernet Gateway Service (EGS) software. The system host is also a web server that hosts a tag monitoring web application that provides a user interface to the system. In various embodiments, more than one system host resides on the LAN and includes applications to continuously interact with the receivers using Ethernet Gateway Service (EGS) software.

The EGS software is a Windows service which runs continuously in the background and has no direct interaction with the user. The EGS includes the following functions:

1) Periodically reads data from each receivers chirp page at a predetermined interval. If the data is successfully read, the EGS writes a confirmation message to the receiver's host page.

2) Reviews the new chirp data to identify any tag which displays a low battery signal. In various embodiments, all Tag ID numbers are even numbers and a low battery signal is represented by odd numbers equal to the Tag ID+1. Any low battery tag information is stored in a database.

3) Stores chirp, tag, receiver and attenuation data in the database.

4) Writes new attenuation settings to each receiver at intervals prescribed by an auto-attenuation schedule in the database.

5) Optionally monitors the data to determine if a specific tag that was being detected by a specific receiver is no longer being detected, and sends an email notification to a list of desired recipients informing them of this event. As part of this function, when a tag that was no longer being detected, begins again to be detected, a notice is posted in a Windows Application Log on the Host PC.

In various embodiments, the monitoring web application is an ASP (Active Server Page) application designed to run on a Windows IIS (Internet Information Service) web server. In various embodiments, the monitoring web application includes two web pages; a login page, and the main application page.

Users can login to the system with one of four levels of access.

Level 1 access allows a user to locate items in the system.

Level 2 access allows a user to Level 1 access plus the ability to maintain tags and items.

Level 3 access allows a user Level 2 access plus the ability to configure the system.

Level 4 access allows a user Level 3 access plus the ability to administer the system.

In various embodiments, a user logged in at level 1 has access that includes the following functions:
Select a facility plan and request the display of an item located in that facility.
Select an item to display its last know location on whatever facility plan it was last located.
Display a graphical history of an item location area within a time frame specified by the user.

In various embodiments, a user logged in at level 2 has access that includes the following functions:
Access to level 1 functions.
Add tags to the system, change their chirp rate or remove tags from the system.
Add items to the system, change the item descriptions or remove items from the system.
Associate an item with a tag, change an existing association between an item and tag, or dissociate a tag from an item.

In various embodiments, a user logged in at level 3 has access that includes the following functions:
Access to level 2 functions.
Add a facility plan to the system, change an existing facility plan or delete an existing facility plan. In various embodiments, a facility plan includes a description, a Jpeg image, origin point coordinates, two scale point coordinates, and the represented distance between the two scale points.
Add a location to the system, change an existing location, or delete an existing location. For example, a location may be a rectangular region within a facility plan which consists of a description, and the coordinates of two opposing corners.
Add a receiver to the system, change an existing receiver, or delete and existing receiver. As an example, a receiver can include of a description, an IP Address, a horizontal attenuation setting or set to automatic, a vertical attenuation setting or set to automatic, the facility plan in which the receiver is located, and the coordinates of the receiver within the facility. In various embodiments, if a receiver's attenuation is set to automatic, its actual attenuation value will be changed on regular intervals in accordance with the values found in an Auto-Attenuation table. In various embodiments, all receivers in the system that have their attenuation values set to automatic will have the same actual attenuation values as each other, at approximately the same time.
Edit the Auto Attenuation schedule. In various embodiments, the Auto Attenuation schedule includes a table of data stored in the database which defines which attenuation values to use in the receivers set to automatic, how long that attenuation value should be used, how consistent the duration of the attenuation value should be, and what physical distance should be associated with that attenuation value.
Edit Default Settings. In various embodiments, Default Settings include of a Default Location that is displayed on login, the Default COM Port of the Host PC that will be used for the tag programmer, the History Frame Count which sets the resolution of the item history display, the Show Tagged Indicator In Items List which when enabled causes a “T” to be displayed in the list of items next to items that have been tagged, and numerous display settings including:
   Skip Circle Count which is the number of the highest attenuation circles to ignore when creating the graphical tag location display. The system strives to display the smallest area around a receiver (the highest attenuation) in which a tag chirp is recorded using discrete distances corresponding to discrete attenuation values, however the nature of the system is not precise. Chirps may occasionally be detected at attenuation values higher than expected. The Skip Circle Count allows the system to ignore the chirps detected at the higher attenuation settings thus displaying a larger but more likely area in which the tag resides.
   # Of Receiver Signals which is the number of receivers used to define the area in which the tag most likely resides when the Find Target option is enabled. When set to a value of 1, the area displayed will be a circle around the receiver which detects chirps at the highest attenuation value with deference to the Chirp Count Threshold. The diameter of the circle will be the smallest circle (highest attenuation) in which chirps are recorded with deference to the Skip Circle Count. When the # Of Receiver Signals value is greater than 1, the area displayed will be the intersection of the smallest circles (highest attenuation) emanating from the receivers which record chirps at the highest attenuation settings with deference to the Chirp Count Threshold and the Skip Circle Count. For example, if the # Of Receiver Signals value is set to 3, and 5 receivers are recording chirps for one particular tag, then the 3 receivers that record chirps at the highest attenuation setting will be used to create the area displayed. Furthermore, if the smallest circles (highest attenuation) of the 3 receivers do not overlap, then the next smallest circle for each of the 3 receivers will be used with this process repeating until an area is created where all three receivers overlap. If the # Of Receiver Signals value is set to Max, all receivers that record chirps for a particular tag will be used to create the overlapping area.
   Circle Count which is the number of circles around each receiver to use to create the graphical tag location display. For example, if the Circle Count value is set to 1 and two receivers are recording chirps for a particular tag, the area displayed will be the shape formed by two arcs resulting from the two overlapping circles defined by the highest attenuation at which chirps were detected. If the Circle Count value is set to 2, the area displayed will be the shape formed by two arcs resulting from the two overlapping circles defined by the highest attenuation at which chirps were detected surrounded by the shape formed by two arcs resulting from the two overlapping circles defined by the second highest attenuation, where the inner area is a darker red than the outer area. So in other words, if the Circle Count value is set to 1, the area displayed is created using the highest attenuation detected at each receiver, and if the Circle Count is greater than 1, each next highest attenuation value is used to create an area which is superimposed upon the previous display.
   Duration Multiplier which is the amount of data to use when creating the graphical tag location display. A value of “1” uses all of the chirp data collected as the attenuation values in the receivers increment from lowest to highest. A value of “2” uses all of the chirp data collected as the attenuation values in the receivers increment from lowest to highest and then increment back from highest to lowest. Higher Duration Multiplier create a more stable but slower responding graphical display.
   Show Receiver Icons which when enabled, shows an image of a receiver in location on the facility plan, and provides a numerical display of the number of chirps recorded at that receiver within its duration.
   Show Zone Edges which when enabled shows a thin black rings around each receiver at the edge of each attenuation zone.
   Show Overlap Zone which when enabled shows only the area in which all N receivers overlap, where N is the # Of Receiver Signals value. When used with the Find Target option disabled, the graphical display may show no tag location areas even though the receivers show chirp counts greater than zero. When used with the Find Target option enabled, a tag location zone should always be shown if more than one receiver has chirp counts greater than zero.
   Show All Overlap Zones which when enabled, shows all of the areas created by the overlapping circles emanating from the receivers. When used with the Find Target option disabled, the graphical display may show no tag location areas even though the receivers show chirp counts greater than zero. When used with the Find Target option enabled, a tag location zone should always be shown if more than one receiver has chirp counts greater than zero. This option differs from the Show Overlap Zone option in that it shows not just the area where all N receives overlap, but also with where all N−i receivers overlap where i=1 to N−1. The redness of the overlapping area increases with the number of receivers which overlap that area so that the greatest redness is where the most number of receivers overlap and least where only two receivers overlap.
   Show Receiver Zones which when enabled, shows a circular area around each receiver that is receiving chirps from a particular tag. Where the circular areas from different receivers overlap, the redness of the area is higher, but not to the extent of the Show All Overlap Zones option.
   Find Target which when enabled, increases the diameter circular zone around each receiver until a area is created in which N receiver zones overlap, where N is the # Of Receiver Signals value. See # Of Receiver Signals above.
   Show Target Circle which when enabled, displays a blue circle around the area defined by the overlapping receiver zones. The size of the blue circle is proportional to the size of the overlapping area.

In various embodiments, a user logged in at level 3 has access that includes the following functions:
Access to level 3 functions.
Add users to the system, edit user settings, or delete users from the system. For example, a user can include a user name, password, access level, email address, and text message address.
Add a notification, edit and existing notification, or delete an existing notification. For example, a notification includes an item, a home facility, a time limit, and a list of notification recipients. In various embodiments, when the system detects that a chirp from an items tag has not been recorded in the home facility within the time limit specified, an email and text message is sent to all of the listed recipients.

The main application page includes a graphical representation of a selected or default area, facility or location. The main application page also includes shaded areas associated with the most probable location of tags detected in the area, facility or location. Each shaded area represents the probabilistic location of a detected tag as determined from information retrieved by the system host from receivers detecting one or more of the tags “chirps”. The main application page also includes selection and data display areas to adjust the display and adjust characteristics of the application according to the user's login level.

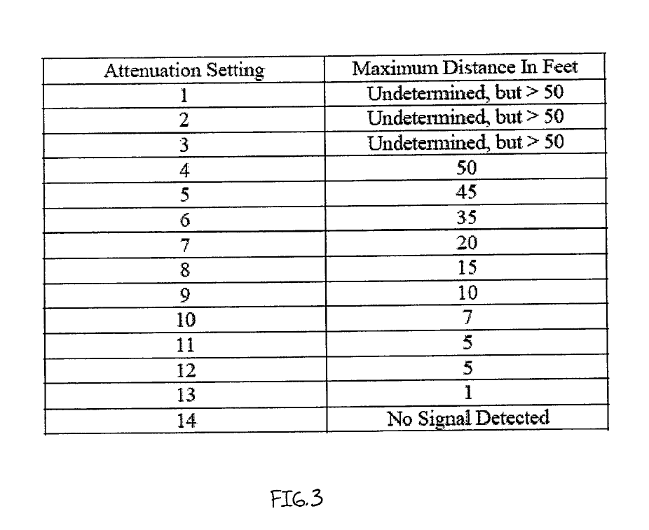

In various embodiments, determining a probable location for a tag includes a process of analyzing historical data received from the tag. In addition to the data “chirped” from the tag, each chirp communicated from a receiver to a system host includes data indicative of the attenuation level of the receiver when the receiver acquired the chirp from the tag. In various embodiments, the receiver changes attenuation based on commands received from the system host. In various embodiments, the system host includes setup data related to the reception area shape of each receiver for various attenuation levels of the receiver. In various embodiments, the attenuation data for a receiver includes a table with discrete attenuation levels and corresponding information describing the receivers reception area shape. In various embodiments, the attenuation data for a receiver includes one or more equations describing the receivers reception area shape as a function of attenuation settings. In various embodiments, the reception area of multiple receivers are strategically overlapped to allow determinations of more precise tag location probabilities. FIG. 3 illustrates a discrete attenuation table according to one embodiment of the present subject matter.

In various embodiments, the system utilizes chirp count per attenuation level of multiple receivers to define a region in which the tag is located. In some embodiments, the system displays areas of increasing probability for the position of a tags. In some embodiments, the system displays a history of a tag's location or probable locations. In various embodiments, the system allows definition, monitoring and display of multiple areas or facilities using RFID tags. In some embodiments, the system allows dividing an area or facility into one or more locations. In various embodiments, the system allows for graphically zooming and panning an area, facility or location. In various embodiments, the system sends an e-mail or text message to a list of recipients when a tag is no longer detected or when a tag has indicated a low battery. In various embodiments, the system is able to identify the last determined location of a tag. In various embodiments allow the system to display and/or identify movement of a tag using the database of received chirps transmitted by the tag and received by one or more receivers. In various embodiments, an asset is associated and cross referenced with a tag such that by monitoring the location of a tag results in monitoring the location of the asset.

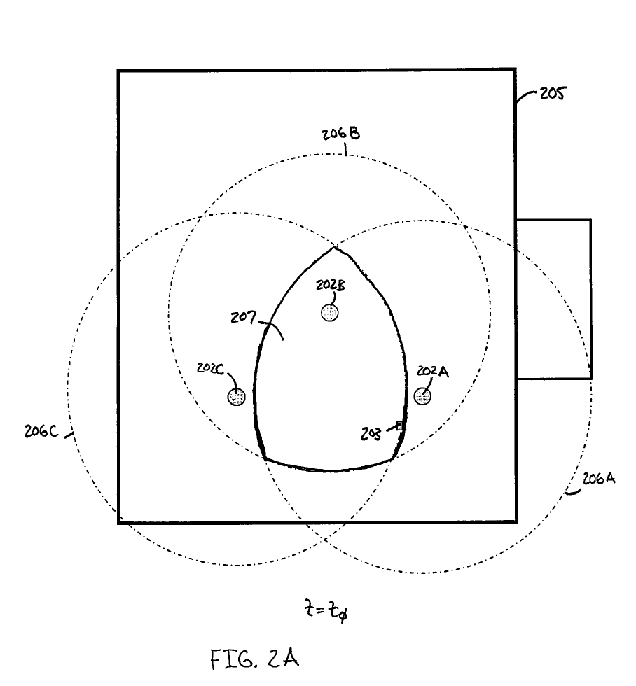

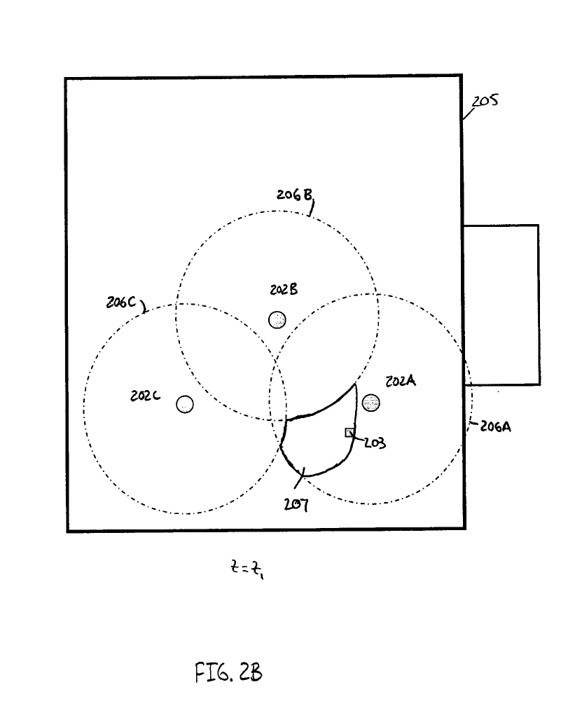

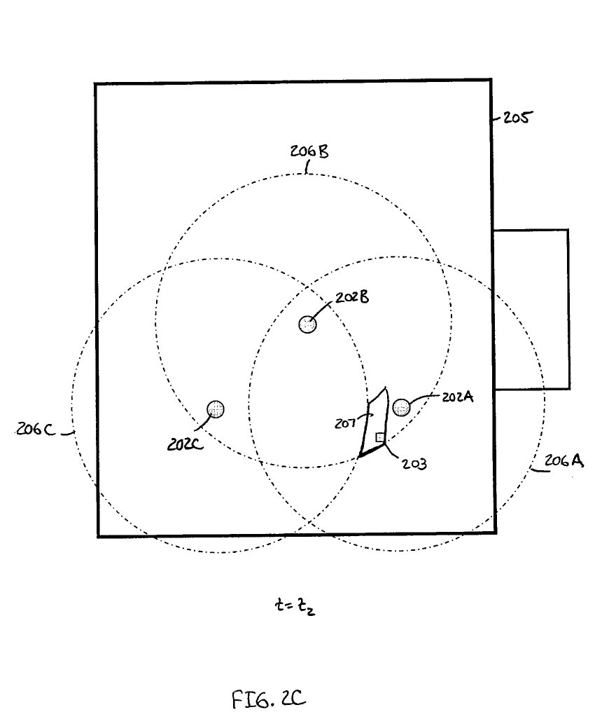

In various embodiments, an auto-attenuation feature allows more precise location of tags by using the system host computer to vary and take into account the attenuation of level of each receiver when each receiver acquires a chirp. FIG. 2A illustrates a system according to one embodiment of the present subject matter. The system includes five receivers 202A-202C monitoring a facility 205 and a tag 203. The receivers are networked to a system host using a local area network (LAN). The reception pattern of each receiver is illustrated by a dashed circle 206A, 206B, 206C, surrounding each receiver. Each receiver includes a processor to monitor tag chirps transmitted by tags in each receiver's reception pattern. In various embodiments, each receiver includes a processor to interface to and communicate over the LAN. In various embodiments, the system host, also connected to the LAN, extracts “chirp” data from each receiver and transmits parameters to each receiver to regulate the operation of the receiver. The system host includes information for each receiver including each receiver's position in the facility and information indicating the expected reception range of each receiver for various receiver attenuation levels. From the acquired chirp data of the tag in the embodiment of FIG. 2 the system host can determine a probable location of the tag for display to the user as shown by area 207 bordered by solid lines following the expected reception range of each receiver detecting the “chirp” of the tag 203

In various embodiments, receivers operate in an auto-attenuation mode. In an auto-attenuation mode of operation, the system host sets parameters to vary the attenuation of transmissions acquired at the receivers according to a predetermined schedule. Different receiver attenuation levels result in different reception patterns. For example, a higher attenuation level applied to a receiver may result in a smaller reception pattern in one embodiment of the present subject matter. In the embodiment of FIG. 2, each receiver applied a low attenuation to acquired chirps. Therefore, receivers 202A, 202B and 202C received a chirp transmitted by the tag 203. The receivers decode and store the chirp data along with receiver information including attenuation data for subsequent retrieval by the system host. The system host, upon retrieval of each receiver's stored data, uses the data to determine and display a probable location 207 for the tag.

FIG. 2B illustrates the embodiment of FIG. 2A at a period of time, t₁, subsequent to time t₀ illustrated in FIG. 2A. In FIG. 2B, the receivers, 202A, 202B and 202C, operating in auto-attenuation mode, adjust their attenuation levels according to commands issued to the receivers over the LAN from the system host. The attenuation commands have resulted in smaller reception patterns for each receiver. Thus, a chirp issued by the tag 203 is detected by only receiver 202A. Using the chirp data acquired from the situation illustrated in FIG. 2, along with the prior collected chirp data acquired in the scenario of FIG. 1, the system host can determine a relatively more precise location of the tag for display to a user. Note that in the embodiment of FIG. 2B, the fact that receivers 202B and 202C did not detect the chirp of tag 203 allows the system host to narrow the probable location area 207 by excluding the expected reception area 206B, 206C of receivers 202B and 202C.

FIG. 2C illustrates the embodiment of FIGS. 2A and 2B at a period of time t₂ subsequent to time t₁, illustrated in FIG. 2B. In FIG. 2C, the attenuation levels of the receivers have again been adjusted by commands issued to the receivers from the system host over the LAN. The commands have resulted in the reception patterns illustrated 206A, 206B, 206C. Thus, a chirp issued by the tag 203 in the facility 205 is detected by receivers 202A, and 202B. Using the chirp data acquired from the situation illustrated in FIG. 2C, along with the prior collected chirp data acquired in the scenarios of FIGS. 2A and 2B, the system host can determine a even more precise location 207 of the tag 203 for display to a user.

In various embodiments, the auto-attenuation feature adapts the system host to vary the attenuation of each receiver according to a predetermined schedule. As chirp data is collected from the receivers along with the receiver's attenuation data, the system host determines more and more precise location probabilities for tags associated with multiple chirps, at multiple receivers where the receivers have acquired the chirps using multiple attenuation levels. Set-up of the auto-attenuation feature includes selecting a schedule for changing the attenuation levels of the receivers. During auto-attenuation operation of the system, the system host transmits commands to set the attenuation level of each receiver according to a selected schedule. In various embodiments, each receiver stores transmitted attenuation data for future reference. In various embodiments, the attenuation data is stored on the receivers host web page. In various embodiments, each receiver has a horizontal antenna and a vertical antenna. When the system is operating and using the auto-attenuation feature, the system host can command attenuation levels of each antenna of a receiver individually according to a predetermined schedule. In various embodiments, data acquired from each receiver will include data indicative of the attenuation level of each antenna associated with the receiver. In various embodiments, the system host deviates from the selected schedule to maintain an attenuation level or force a desired attenuation to accommodate receiving chirps from one or more tags determined not to be synchronized to the attenuation schedule. Tag chirp timing can vary from a short period of time, to assure the tag is closely monitored, to a long period of time, to conserve the battery life of the tag. Tag chirp timing in a system can vary, for example, from several seconds to several hours.

As tag chirps are detected, each receiver decodes the chirped data and stores the decoded chirped data along with receiver data, including data indicative of the attenuation level of the receiver at the time each chirp was received. Each receiver continues to store chirp event data as the data is received. In various embodiments, the system host interrogates the stored data of each receiver and acknowledges reception of the data such that the receiver need not continue to save the acknowledged data. In various embodiments, the receiver stores and protects acquired data on uniquely identified web pages. As the data on each web page is acquired by the system host, the system host stores an acknowledgement including the web page's unique identifier on the host page of the receiver. The acknowledgement allows the receiver to unprotect the data and use the acknowledged web page space for subsequent operations.

“Chirps” from tags include data encoded using data bits. Data bits transmitted by the tags are encoded into symbols that span four base frequency band bits. The first base frequency band bit is always a “1” (transmitter on) and the last base frequency band bit is always a “0” (transmitter off). The second base frequency band bit matches the data bit itself and the third base frequency band bit is always the complement of the data bit. So sending a data bit of 1 is equivalent to sending the base frequency band symbol “1-1-0-0” and sending a data bit of 0 is equivalent to sending “1-0-1-0”.

In various embodiments, tag data nibbles are encoded into byte-long symbols that span eight data bits. The first four data bits are encoded true and the last four are encoded as complement. This way the symbol can be checked for corruption on a nibble-by-nibble basis. Furthermore the Preamble Symbol, Start Symbol, and Median Symbol are be encoded so that they will fail such a check and thus provide more definite frame alignment and higher data integrity in the case of collision.

In various embodiments, the chirp transmission progresses as follows:

BYTE 1-2=PREAMBLE SYMBOL (0xFF)
BYTE 3-4=START SYMBOL (0x7F)

### BYTE 5-10=1st SET OF DATA NIBBLES W/COMPLEMENTS

BYTE 11=MEDIAN SYMBOL (0x80)

### BYTE 12-17=2nd SET OF DATA NIBBLES W/COMPLEMENTS

The Preamble Symbols train the decoder to find the “0” to “1” transition that occurs at the beginning of every data bit symbol. It's repetitive nature allows the preamble to be verified to avoid mis-registration due to a collision or noise event. Also, since the transition is always from “0” to “1” the decoder can “re-sync” at each data bit symbol and will not acquire timing skew due to the natural difference in response time between “0” to “1” transitions and “1” to “0” transitions providing an advantage over the other common decoding schemes.

The Start Symbol provides a means of synchronizing the decoder with the sequence of data encoded in the transmission sent by the tag. The decoder performs various checks on the symbol to avoid false starts in the presence of significant RF interference or contention with another tag. The receiver then decodes the first set of data if possible. From time to time decoding will be interrupted due to RF interference from unwanted sources and from “collisions” which will occur when transmissions from two different tags impinge on the same receiver. The decoder uses the complement test to check for these conditions and to reject the decoded data so as to reject the erroneous code.

After the first set of data is transmitted the Median Symbol is transmitted. The Median gives the decoder a second chance to synchronize with the chirp in case of interference or contention during the first half of the chirp transmission. It is devised to be highly distinguishable from the Start Symbol. The decoder will accept as a valid decode the first set of data that passes both the byte-by-byte complement check and the data set-long checksum test.

It is acceptable to not successfully decode all chirps from a given tag from time to time due to interference and collisions with other tags. Unsuccessfully decode chirps result in a “no decode” state. The transmission chirp protocol described above provides for DC Balance, better data-frame registration, and better error checking and data recovery, and better rejection of erroneous tag IDs.

This document is intended to cover adaptations or variations of the present subject matter. It is to be understood that the above description is intended to be illustrative, and not restrictive. The scope of the present subject matter should be determined with reference to the appended claims, along with the full scope of equivalents to which such claims are entitled.

What is claimed is:

1. A system for locating one or more radio frequency identification (RFID) tags, the system comprising:
a radio frequency (RF) receiver including a receiver processor, the receiver adapted to programmably adjust reception range depending on a programmably variable attenuation parameter, the receiver further adapted to receive identification data from the one or more RFID tags; and
a system host adapted to:
receive RFID tag data from any of the one or more RFID tags within the reception range and receiver attenuation data associated with the receiver; and
provide an estimated location area for a received RFID tag using the RFID tag data and the receiver attenuation data.

2. The system of claim 2, wherein the system host is adapted to provide the estimated location area using a plurality of different reception ranges of the receiver.

3. The system of claim 2, comprising at least one additional receiver, wherein the system host is adapted to provide the estimated location area further using information from the at least one additional receiver.

4. The system of claim 3, further comprising a large area network (LAN) connecting one or more of the receivers and the system host.

5. The system of claim 5, wherein at least one of the receivers includes a processor connected to the LAN and adapted to manage communications between the system host and the at least one of the receivers.

6. The system of claim 4, wherein the system host executes an application capable of being accessed with a web browser.

7. The system of claim 6, wherein the application is further adapted to limit access to the system based on a login security level.

8. The system of claim 1, further comprising a tag programmer connected to the system host and adapted to program the one or more RFID tags

9. The system of claim 8, wherein the tag programmer is adapted to program the one or more RFID tags with identification data and transmission timing data.

10. A method comprising:
receiving data from one or more radio frequency identification (RFID) tags using one or more radio frequency (RF) receivers, at least one of the receivers adapted to programmably adjust reception range based on an attenuation setting;
collecting the data and information about the attenuation setting from the one or more receivers;
identifying a probable location area for each of the one or more RFID tags received using the data and the attenuation setting; and
displaying the probable location area of the one or more RFID tags.

11. The method of claim 10, further comprising programming each of the one or more RFID tags using a programmer.

12. The method of claim 11, wherein programming each of the one or more RFID tags includes programming the one or more RFID tags with information for uniquely identifying each tag.

13. The method of claim 11, wherein programming each of the one or more REID tags includes programming the one or more RFID tags with timing information for scheduling each tag to chirp the data.

14. The method of claim 13, wherein programming the one or more RFID tags with timing information includes programming the one or more RFID tags with staggered timing information to reduce chirp interference between the one or more RFID tags.

15. The method of claim 10, further comprising adjusting attenuation settings for each receiver.

16. The method of claim 15, wherein collecting the data is performed by a host computer.

17. The method of claim 15, wherein collecting the data and information about the attenuation setting includes receiving attenuation settings for each of the receivers.

18. The method of claim 10, wherein displaying the probable location area includes displaying a descriptive label of an asset associated with each RFID tag.

19. The method of claim 10, wherein displaying includes graphically displaying the one or more RFID tags relative to each of the one or more receivers.

20. The method of claim 10, further comprising displaying movement of one or more of the one or more RFID tags over a predetermined interval of time using at least the received data.

21. The method of claim 10, further comprising identifying a RFID tag with a low battery based on the received data.
